(19) United States
(12) Patent Application Publication
(10) Pub. No.: US 2016/0019799 A1
(43) Pub. Date: Jan. 21, 2016

(54) VISUAL LEARNING SYSTEM AND METHOD

(71) Applicant: Allison Anthony Hosang, Columbus, OH (US)

(72) Inventor: Allison Anthony Hosang, Columbus, OH (US)

(21) Appl. No.: 14/332,452

(22) Filed: Jul. 16, 2014

(51) Int. Cl. G09B 3/00; G09B 19/02; A47G 23/03; G09B 21/00; G09B 23/36; G09B 19/00; G09B 23/28

(52) U.S. Cl. CPC G09B 3/00; G09B 19/0023; G09B 19/02; G09B 23/28; G09B 19/00; G09B 19/0061; G09B 21/009; G09B 23/36; A47G 23/0306

(57) ABSTRACT

The teaching system comprises at least one themed set of one or more learning cards having a common graphical representation of a themed subject matter and at least one testing placemat comprising a testing area having a graphical representation of a correlating themed subject matter of the at least one themed set. The testing placemat may have a contoured perimeter adapted to fit at least partially around the base of tableware such as a plate or bowl, wherein a learner's knowledge of the themed subject matter is tested during their mealtime.

### BACKGROUND

The present invention relates generally to methods of teaching and testing children, and in particular, a visual teaching system and method that can be implemented during childhood day to day activities.

Parenting or caring for a child can be one of the most challenging and time consuming responsibilities. Typical day to day child caring activities include numerous tasks such as bathing, clothing, feeding, and transporting the child—which collectively can seize up a large portion of the day. Moreover, working parents are obligated to carry out these activities in addition to their daily employment, which leaves very little time to engage their child with learning activities outside of daycare or preschool.

Moreover, it is more important than ever to engage with and encourage the learning of a child during early childhood in order for the child to be competitive within the classroom in their future years. With that said, what is lacking is a teaching and testing method that can be easily implemented during routine childcare activities.

The present invention provides a system and method for facilitating and encouraging childhood learning. The difficulties inherent in the art are therefore overcome in a way which is simple and efficient—which provide better and more advantageous results when it comes to learning at a young age.

### SUMMARY

For the foregoing reasons, what is needed is to provide a learning system and method that implements visual learning and testing during routine daily child caring activities.

The teaching system comprises at least one themed set of one or more learning cards having a common graphical representation of a themed subject matter and at least one testing placemat comprising a testing area having a graphical representation of a correlating themed subject matter of the at least one themed set. The testing placemat may have a contoured perimeter adapted to fit at least partially around the base of tableware such as a plate or bowl, wherein the child learner's knowledge of the themed subject matter is tested during their mealtime. The testing placemat serves the dual purposes of collecting food and beverage spillage as well as providing the child learner an unobstructed view of the testing area while the child learner is eating their meal.

Generally speaking, the child learner is sequentially presented throughout daily activities the one or more learning cards within the at least on themed set. During the presentation, the child learner is prompted to answer questions and/or leading question statements about the graphical representation found on each of the one or more learning cards within the themed set.

Once it is determined from observation that the child learner is ready for testing regarding a certain themed subject matter, the at least one testing placemat is presented to the child learner with the themed subject matter during the child learner's mealtime. The child learner's knowledge of the themed subject is then tested. If the child learner successfully completes the testing placemat based on the observation of the teacher, the child learner has passed the test. If the child learner does not successfully complete the testing placemat, further presentation of the one or more learning cards are presented and questioned throughout the daily routine until the child learner successfully completes the themed subject matter presented on the testing placemat.

In a version, the teacher system may provide one or more teacher guidance cards, each teacher guidance card provides teaching instructions correlating to one or more learning cards, wherein the child learner is prompted in accordance with the teacher guidance card to familiarize the child learner with the themed subject matter provided on the learning card. Moreover, teacher guidance cards can be provided to correlate with one or more testing placemats, wherein the cards provide testing instructions, questions and answers.

In another version, one or more means for securely attaching the testing placemat with a flat surface is provided, whereby the placemat is secured into place during the child learner's mealtime. Moreover, the one or more means for securely attaching the testing placemat with a flat surface can also be used elevate the testing area of the testing placemat in order to provide an enhanced viewing angle of the testing area of the placemat.

Still other benefits and advantages of the invention will become apparent to those skilled in the art to which it pertains upon a reading and understanding of the following detailed specification.

### BRIEF DESCRIPTION OF THE DRAWINGS

These and other features, aspects, and advantages of the present invention will become better understood with regard to the following description, appended claims, and accompanying drawings where:

FIG. 1A illustrates an example learning card with a shapes themed subject matter in accordance with one version of the invention;

FIG. 1B illustrates an example learning card with a shapes themed subject matter in accordance with one version of the invention;

FIG. 1C illustrates an example testing placemat having a shapes themed subject matter in accordance with one version of the invention;

FIG. 1D illustrates an example teacher guidance card which correlates to a shapes themed subject matter in accordance with one version of the invention;

FIG. 2A illustrates an example learning card with a numbers themed subject matter in accordance with one version of the invention;

FIG. 2B illustrates an example learning card with a numbers themed subject matter in accordance with one version of the invention;

FIG. 2C illustrates an example testing placemat having a numbers themed subject matter in accordance with one version of the invention;

FIG. 2D illustrates an example teacher guidance card which correlates to a numbers themed subject matter in accordance with one version of the invention;

FIG. 3 illustrates an example testing tracking chart in accordance with one version of the invention;

FIG. 4 is a flow diagram illustrating a method of teaching a child learner according to a version of the present invention; and

FIG. 5 is a flow diagram illustrating a method of teaching a child learner according to a version of the present invention.

### DESCRIPTION

Referring now to the drawings wherein the showings are only for purposes of illustrating a preferred version of the invention and not for purposes of limiting the same.

The following description of exemplary embodiments of the invention is not intended to limit the scope of the invention to these exemplary embodiments, but rather to enable any person skilled in the art to make and use the invention.

The present invention includes a system and method of using one or more learning cards in conjunction with correlating themed subject matter testing placemats. The learning cards are designed to take advantage of strong visual learning capabilities of primarily Kindergarten age and younger in order to teach the themed subject matter thereon. However, it will be known that the system and method can be utilized to assist with teaching special needs students, nursing home patients, and elderly people. The themes illustrated within the teaching system and method may include a vast array of subject matter; for example, colors, shapes, numbers, alphabet, language skills, object recognition, body parts, animals, emotions, phonics, geography, sign language and other school subjects.

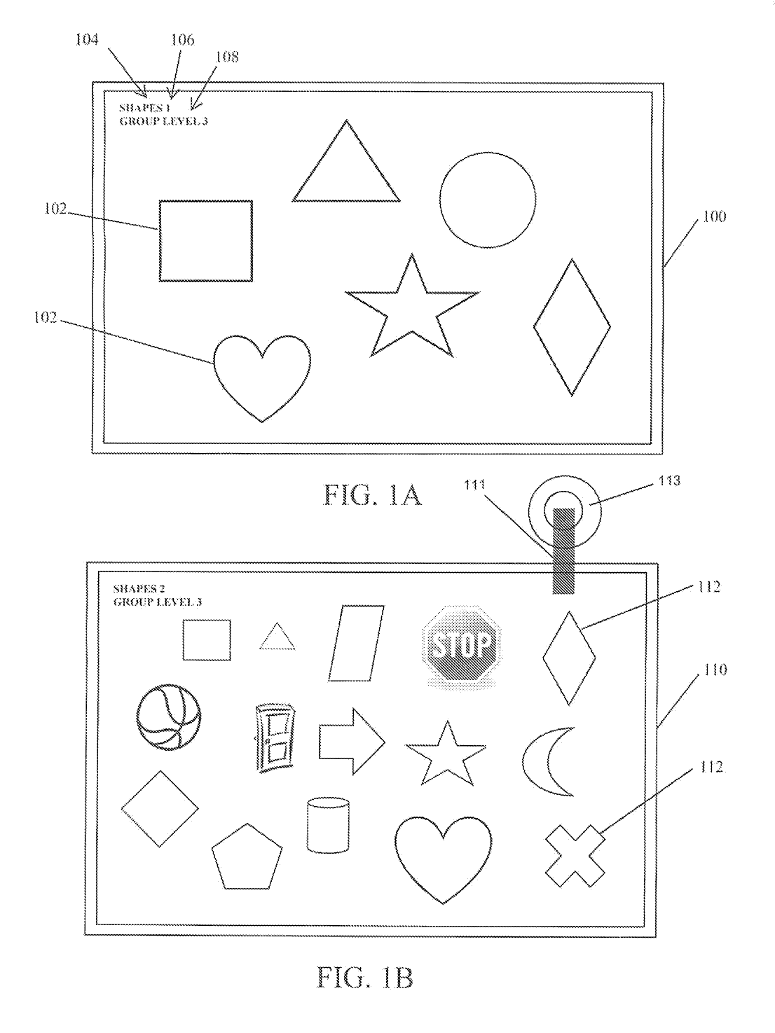

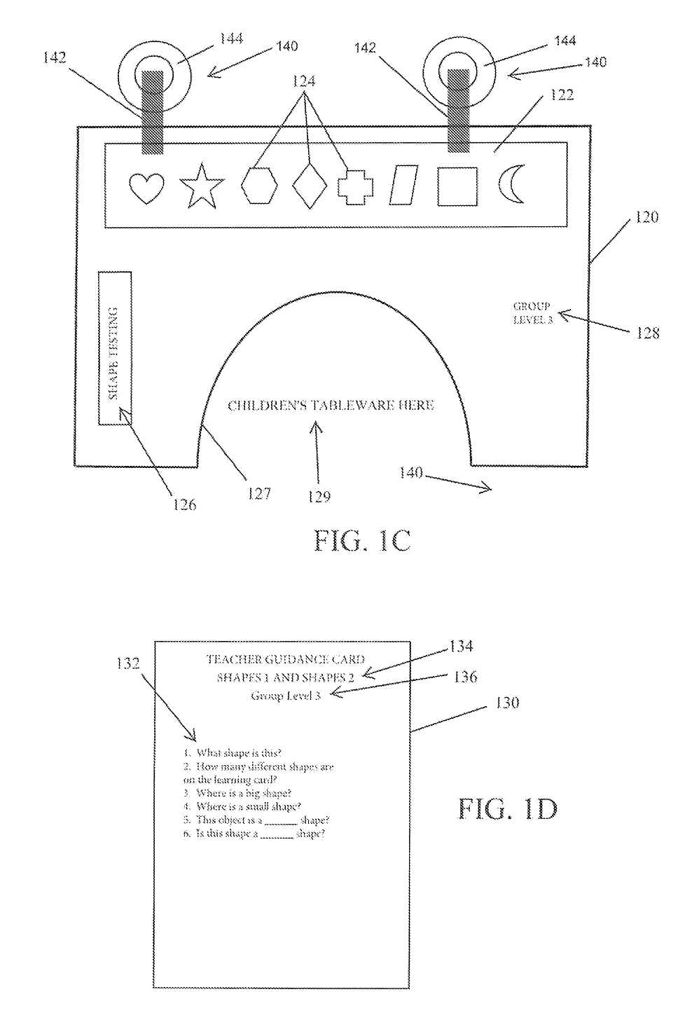

FIG. 1A-FIG. 1D illustrate a first version of the system and method for teaching a child learner having a themed subject matter. FIG. 1A and FIG. 1B illustrate example learning cards 100, 110 that make up a themed set of one or more learning cards having a graphical representation of a themed subject matter. The learning card 100 illustrating a basic learning card having various simple shapes 102 which collectively comprise the themed subject matter. Learning card 110 illustrates a more complex learning card which has various shapes and objects representative of shapes 112 which collectively comprise the themed subject matter. Learning cards within a themed set may vary in complexity. This enables the ability to present the cards within a themed subject matter in a predetermined sequence based on complexity.

Themed sets of learning cards can be grouped together to form group levels. Group levels indicate learning cards that have been designated for children having a certain skill level. Group levels may contain a plurality of themes in order to present an overall package of learning material for the teacher and the child learner.

Moreover, one or more group levels can be combined to create an overall teaching program. Teaching programs may contain one or more group levels that are sequentially presented to the child learner over the course of the program. Sequences may be based on complexity of subject matter and the skill set of individual child learners. It will be known that there are a myriad of different ways the learning cards can be organized and presented by theme, complexity and with other variations.

In the illustrated version, learning cards are labeled according to their themed subject matter within a themed set 104, card number 106 within the themed set 104, and by an overall group level number 108. Alternatively, learning cards may be labeled by utilizing color coding, identifying shapes, or any other means of visual organization of the learning cards by themed subject matter, card number, and group level.

The learning cards 100, 110 can be made of any material that is durable, firm and easy to clean, in order to withstand utilizing the cards throughout daily routines involving children, such as bathing, eating, and other challenging activities. It will be known that the learning cards can be in the form of any shape, size, or color configuration. For example, aside from the standard rectangular shape, the learning cards can be circular or an irregular shape such as the shape of an identifiable object.

In addition, a version of the invention may comprise one or more means for attachment with a flat surface 109. In the illustrated version, the means for attachment with a flat surface 109 is a combination suction cup 113 having a clip 111, wherein the suction cup is securely attached to a flat surface and the clip is attached to the learning card 110. This enables the learning cards to be attached to various flat surfaces throughout routine daily activities and throughout the implementation of the teaching system and method.

As illustrated in FIG. 1C, the teaching system further comprises a testing placemat 120 comprising a testing area 122 having a graphical representation of a correlating themed subject matter of the one or more learning cards within the themed set which comprises learning cards 100 and 110. In the version, the correlating themed subject matter is graphically illustrated as various shapes 124 found within the testing area 122. Testing placemats are labeled according to their correlating theme set 126 and group level 128.

Moreover, in the illustrated version, the testing placemat 120 comprises a perimeter 127, wherein the perimeter 127 is contoured to adapt to fit partially around or completely around the base of tableware 129 such as a bowl or plate while simultaneously visibly presenting the testing area 122 in front of the child learner. As illustrated in FIG. 1C, the contoured perimeter 127 forms an arch shape. However, alternatively, the contoured perimeter may form other shapes including but not limited to a rectangle, square, circle, semi-circle, oval, or any other shape that can be formed in order to fit around the base of tableware. The testing placemat 120 serves the dual purposes of collecting food and beverage spillage as well as providing the child learner an unobstructed view of the testing area 122 while the child learner is eating their meal.

The testing placemat 120 can be made of any material that is durable, firm, lightweight, and easy to clean, in order to withstand the normal requirements of a traditional placemat. Ideally, the placemat is made of a robust material layered with laminate. Moreover, it will be known that the placemat can vary in size according to the child learner and the size of the eating surface. The smallest sized placemat being able to fit on a highchair that is commonly known in the art.

In addition, a version of the invention may comprise one or more means for attachment with a flat surface 140. In the illustrated version, the means for attachment with a flat surface 140 is a combination suction cup 144 having a clip 142, wherein the suction cup 144 is securely attached to the flat surface and the clip 142 is attached to the testing placemat 120. This ensures that the testing placemat is secured into place during the child's mealtime and testing. Optionally, the one or more means for attachment with a flat surface 140 can also be used and positioned such that the testing area 122 is slightly elevated above the flat surface in order to provide an enhanced viewing angle of the testing area 122 of the testing placemat 120. As an alternative, a means for resisting the movement of the placemat may be utilized. Aside from utilizing the above mentioned combination suction cup having a clip as a means for resistance, the backside of the testing placemat may be coated with a non-slippery substance in order to prevent the testing placemat from moving on a flat surface.

Optionally, as illustrated in FIG. 1D, a version of the invention may include one or more teacher guidance cards 130. Generally speaking, teacher guidance cards 130 provide teaching instructions 132 correlating to one or more learning cards within the themed set, wherein the child learner is prompted in accordance with the teacher guidance card to familiarize the child learner with the themed subject matter provided thereon. In the illustrated version, the teacher guidance card 130 correlates with learning card 100 and learning card 110. The teacher guidance card 130 includes teacher instructions 132 comprising a plurality questions and leading question statements relating to the shaped themed subject matter found on learning cards 100 and 110. In the version, teacher guidance cards are labeled according to their correlating theme set and card numbers within the theme sets 134 and group level 136.

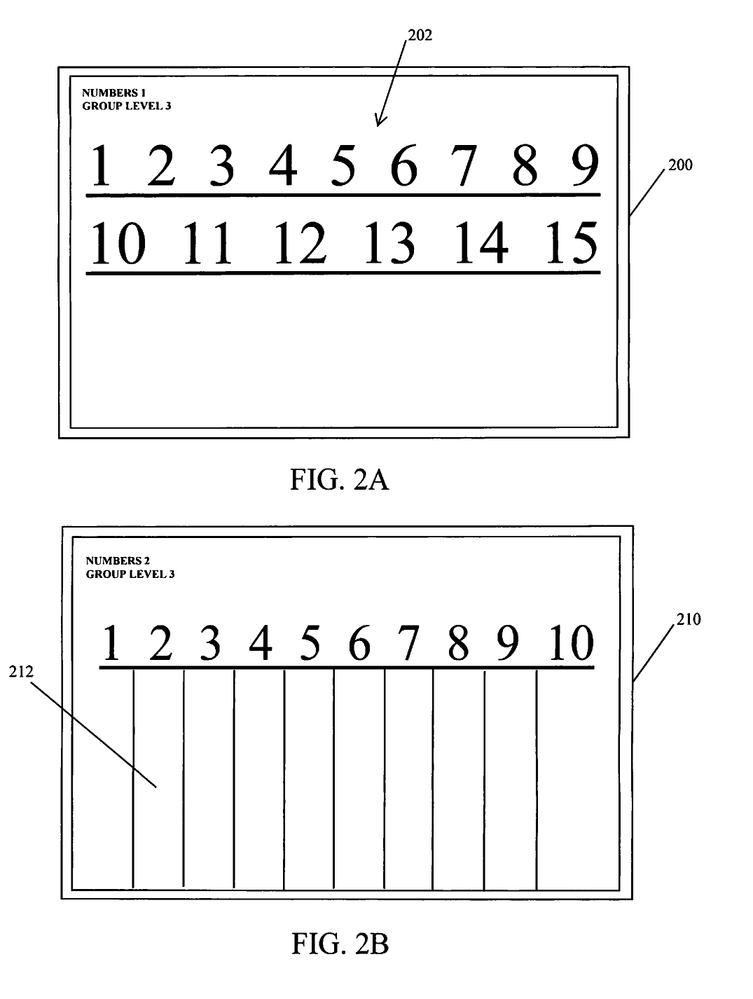

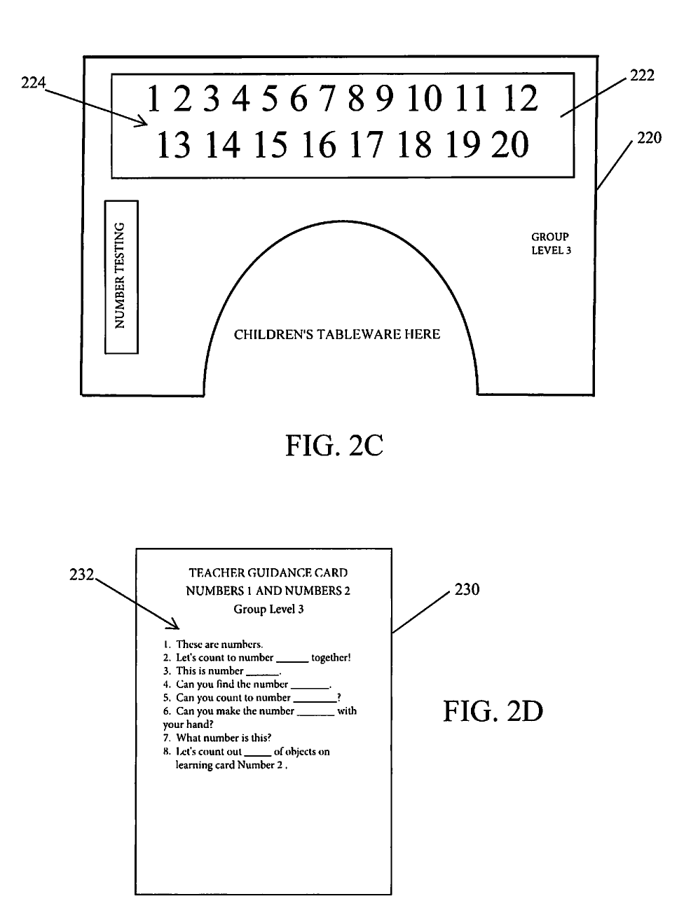

FIG. 2A-FIG. 2D is yet another illustrated example of a version of the teaching system for teaching a child learner having a themed subject matter. FIG. 2A and FIG. 2B illustrate example learning cards 200, 210 that make up a themed set involving numbers. The learning card 200 illustrates a basic learning card having various simple numbers 202 which collectively comprise the themed subject matter. Learning card 210 illustrates a learning card which has the ability to be utilized as an object counter. The child learner can be prompted to count out objects and be instructed to place the correct number of objects within the designated number column 212.

As illustrated in FIG. 2C, the teaching system further comprises a testing placemat 220 comprising a testing area 222 having a graphical representation of a correlating themed subject matter of the one or more learning cards within the themed set. In the version, the correlating themed subject matter is graphically illustrated as various numbers 224 found within the testing area 222.

As illustrated in FIG. 2D, the version includes a teacher guidance card 230 which correlates with learning card 200 and learning card 210. The teacher guidance card 230 includes teacher instructions 232 comprising a plurality of leading statements or question relating to numbers and counting found on learning cards 200 and 210.

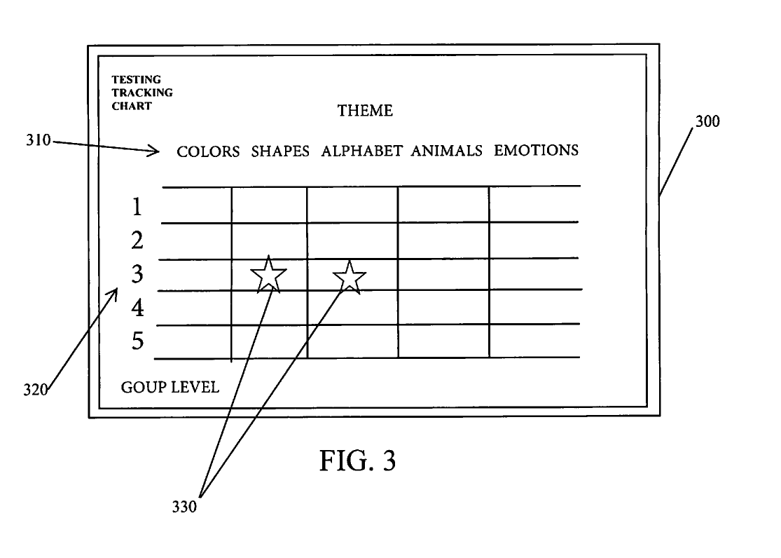

FIG. 3 illustrates a testing tracking chart 300. The testing tracking chart 300 comprises the ability to track a child learner's successful completion of each testing placement according to correlating theme 310 and group level 320. Thus, when a child learner successfully completes a testing placemat, an indication such as a star shaped sticker 330 is placed within the testing placemat corresponding row and column.

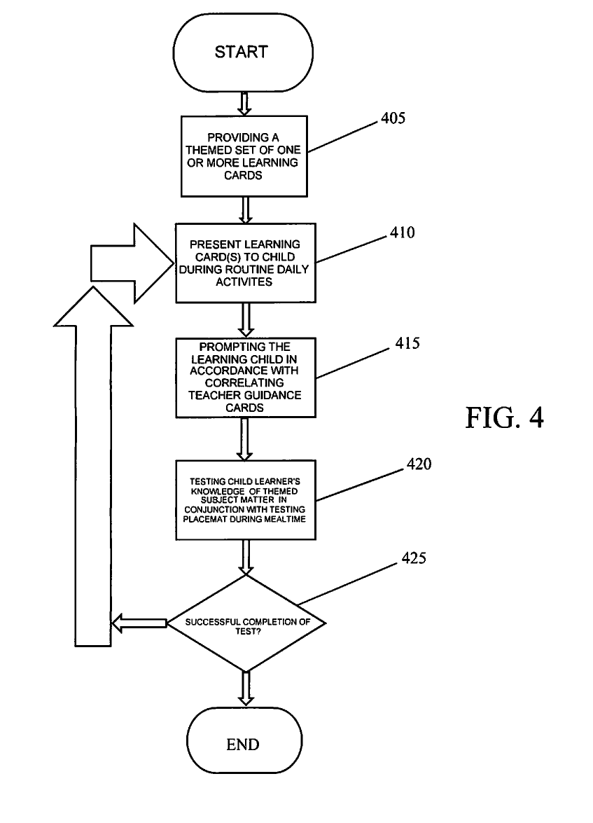

FIG. 4 is a flow diagram illustrating the basic teaching method 400 which utilizes the teaching system according to a version of the present invention.

Teaching method 400, beings with step 405 by providing a themed set of one or more learning cards having a common graphical representation of a themed subject matter. For example, the themed set can be learning cards having various shapes as illustrated by FIG. 1A and FIG. 1B or numbers as illustrated by FIG. 2A and FIG. 2B. Next, in step 410, the themed set of one or more learning cards are presented to the child learner during routine daily activities such as during meal time, transporting, and bathing. During presentation, the teacher prompts (step 415) the child learner in accordance with the one or more teacher guidance cards that correlate with the one or more learning cards. Alternatively, the teacher may elect not to implement the teacher guidance cards, but instead derive and deliver their own set of questions or leading question statements about each learning card.

Once the child learner has demonstrated a sufficiency within the themed subject matter, the child learner's knowledge of the themed subject matter is tested in conjunction with the testing placemat during the child learner's mealtime (step 420). For example, if the themed subject matter is shapes, testing placemat 120 in FIG. 1C is utilized. Alternatively, if the themed subject matter is numbers, testing placemat 220 in FIG. 2C would be utilized.

If the child learner successfully completes the testing placemat based on the observation of the teacher, the child learner has passed the test and the teaching method 400 is over regarding the tested themed subject matter. Otherwise, the process moves forward with step 410 wherein the learning cards are further presented and prompted throughout daily routines to the child learner until the child learner is ready to be tested again. Alternatively, after the successful completion of testing a themed subject matter, method 400 can be carried out sequentially with other themed subject matters.

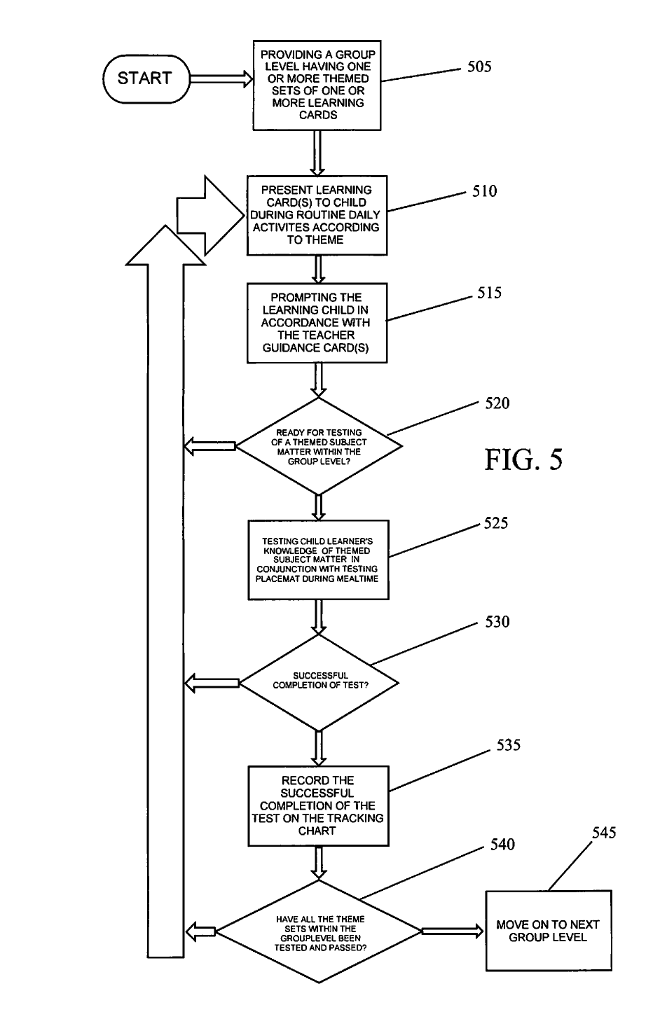

Moreover, the teaching system and method may comprise teaching one or more themed sets simultaneously with individual placemat testing of each themed set within a group level as illustrated by teaching method 500 in FIG. 5. Teaching method 500, beings with step 505 by providing a group level having one or more themed sets of one or more learning cards having a common graphical representation of a themed subject matter. Next, in step 510, the learning cards having different themes within the group level are presented to the child learner during routine daily activities such as during meal time, transporting, and bathing. The teacher has the ability to pick and choose with themed subject matter to teach within group level based on the teacher's object observation of the child learner's strength and weaknesses. During this time, the teacher may prompt the learning child learner in accordance with the one or more teacher guidance cards that correlate with the one or more learning cards that are currently presented to the child learner (step 515).

As illustrated by step 520, if the teacher determines through observation that the child learner has demonstrated a sufficiency within one of the themed subject matters, the child learner's knowledge of the themed subject matter is tested in conjunction with the corresponding themed subject matter testing placemat (step 525).

In step 530 of method 500, the teacher decides whether the child learner has successfully completed the test or the child learner needs to continue with learning. If the test was successfully completed, the success is recorded on the tracking chart (step 535) in regard to the subject matter themed tested on and the group level. If the child learner has not been tested on all of the themed sets within the group level or does not successfully complete one the themed tests, method 500 continues with step 510 focusing on the other themed subject matters that have not yet been tested on and/or the themed subject matter that has not been successfully tested on. If all of the themed subject matters have been tested and successfully passed, method 500 ends or optionally moves onto the next group level within a teaching program. Optionally, after the child learner has successfully completed a themed subject matter, group level, or an entire teaching program, the child learner can be awarded a diploma or a certificate of achievement.

The previously described versions of the present invention have many advantages, including providing learning cards are designed to take advantage of strong visual learning capabilities of primarily pre-kindergarten children in order to teach the themed subject matter thereon. Moreover the invention is easy to implement and creates an efficient, yet relaxed technique for teaching young learners.

The invention does not require that all the advantageous features and all the advantages need to be incorporated into every version of the invention.

All the features disclosed in this specification (including and accompanying claims, abstract, and drawings) may be replaced by alternative features serving the same, equivalent or similar purpose unless expressly stated otherwise. Thus, unless stated otherwise, each feature disclosed is one example only of a generic series of equivalent or similar features.

What is claimed is:

1. A teaching system for teaching a learner, comprising:
(a) at least one themed set of one or more learning cards having a common graphical representation of a themed subject matter; and
(b) at least one testing placemat comprising a testing area having a graphical representation of a correlating themed subject matter of the at least one themed set.

2. The teaching system as in claim 1, wherein the at least one testing placemat further comprises a contoured perimeter adapted to fit at least partially around the base of tableware.

3. The teaching system as in claim 1, further comprising one or more teacher guidance cards, each teacher guidance card providing teaching instructions correlating to a one or more learning cards within the at least one themed set, wherein the learner is prompted in accordance with the teacher guidance card to familiarize the learner with the themed subject matter provided on the learning card.

4. The teaching system as in claim 1, further comprising a tracking chart, wherein the learner's successful completion of each testing placement is recorded thereon.

5. The teaching system as in claim 1, further comprising a means for resisting the movement of the placemat while on a surface.

6. The teaching system as in claim 1, further comprising one or more means for attachment with a surface.

7. The teaching system as in claim 6, wherein the means for attachment with a surface is a suction cup having a clip, wherein the suction cup is securely attached to the surface and the clip is attached to the testing placemat, whereby the placemat is secured into place during the child's mealtime and testing.

8. The teaching system as in claim 6, wherein the one or more means for attachment with a surface is further configured to elevate the testing area towards the learner during mealtime.

9. The teaching system as in claim 1, wherein the one or more themed sets are grouped together according to complexity to form a group level, wherein one or more themes are sequentially presented to the learner in order to familiarize the learner's knowledge of the themed subject matter of the one or more themed sets.

10. The teaching system as in claim 1, wherein the themed subject matter can be selected from the group consisting of colors, shapes, numbers, alphabet, language skills, object recognition, body parts, animals, emotions, phonics, geography and sign language.

11. The teaching system as in claim 1, further comprising providing a tracking chart, wherein the learner's successful completion of each testing placement is recorded thereon.

12. A teaching method for teaching a learner, comprising:
(a) providing at least one themed set of one or more learning cards having a common graphical representation of a themed subject matter;
(b) providing at least one testing placemat comprising a testing area having a graphical representation of a correlating themed subject matter of at least one themed set;
(c) sequentially present the one or more learning cards to a learner;
(d) prompting the learning to answer questions or a leading statement question about each presented learning card to familiarize the learner with the themed subject matter provided on the learning card;
(e) presenting to the learning child the at least one testing placemat during the learner's mealtime; and
(f) testing the learner's knowledge of the themed subject matter provided on the at least one testing placemat.

13. The teaching method, as set forth in claim 12, wherein the testing placemat further comprises a contoured perimeter adapted to fit at least partially around the base of tableware.

14. The teaching method, as set forth in claim 12, further comprising providing at least one teacher guidance card containing teaching instructions correlating to at least one or more learning card within the at least one set; wherein the learning child is prompted in accordance with the teacher guidance card to familiarize the learner with the themed subject matter provided on the at least one learning card before the learner's knowledge of the themed subject matter is tested.

15. The teaching method, as set forth in claim 12, wherein the themed subject matter can be selected from the group consisting of colors, shapes, numbers, alphabet, language skills, object recognition, body parts, animals, emotions, phonics, geography and sign language.

16. The teaching method, as set forth in claim 12, further comprising providing a tracking chart, wherein the child's successful completion of each testing placement is recorded thereon.

17. The teacher system for a learner as in claim 12, wherein one or more themed sets are grouped together according to complexity to form a group level, wherein one or more themes are sequentially presented to the learner in order to familiarize the learner's knowledge of the themed subject matter of the one or more themed sets.

18. A teaching method, comprising:
(a) providing at least one learning card having a graphical representation a themed subject matter;
(b) providing at least one teacher guidance cards containing teaching instructions correlating to the at least one learning card;
(c) providing at least one testing placemat comprising a testing area having a graphical representation of a correlating themed subject matter of at least one learning card;
(d) providing a tracking chart, wherein the child's successful completion of each testing placement is recorded thereon;
(e) presenting the at least one learning card to a learning child;
(f) prompting the learning child in accordance with the teacher guidance card to familiarize the learning child with the themed subject matter provided on the learning card;
(g) presenting to the learning child the at least one testing placemat during the learner's mealtime;
(h) testing the learner's knowledge of the themed subject matter provided on the testing placemat; and
(i) recording the successful completion of the test on the tracking chart in order to track the progress of the child learner.
